(19) United States
(12) Patent Application Publication
(10) Pub. No.: US 2008/0083706 A1
(43) Pub. Date: Apr. 10, 2008

(54) Reverse side film laser circuit etching

(75) Inventor: Josef Kirmeier, Los Gatos, CA (US)

Correspondence Address: Charles L. Hamilton;Fountainhead Law Group PC, Ste. 509, 900 Lafayette St., Santa Clara, CA, 95050, US

(73) Assignee: Mu-Gahat Enterprises, LLC, Sunnyvale, CA (US)

(21) Appl. No.: 11/895,724

(22) Filed: Aug. 27, 2007

Related U.S. Application Data
(63) Continuation-in-part of application No. 11/544,499, filed on Oct. 5, 2006.

(51) Int. Cl. B23K 26/36; B23K 26/00; B23K 26/14

(52) U.S. Cl. 219/72; 219/121.68; 219/121.69

(57) ABSTRACT

In one embodiment the present invention includes a direct-write laser lithography system. The system includes a reel-to-reel feed system that presents the clear film-side of a single-sided metal-clad tape to a laser for direct patterning of the metal. The laser beam is swept laterally across the tape by a moving mirror, and is intense enough to ablate the metal but not so strong as to destroy the tape substrate. In another instance, two specialized lasers are used, one tuned to ablate large field areas, and the other tuned to scribe fine features and lines. The ablated metal blows off in a downward direction and is collected for recycling.

### CROSS REFERENCE TO RELATED APPLICATIONS

The present application is a continuation-in-part (CIP) application of U.S. patent application Ser. No. 11/544,499, titled “Reverse Side Film Laser Circuit Etching”, filed Oct. 5, 2006.

### BACKGROUND

The present invention relates to flexible circuits, and in particular to methods, systems, and devices for manufacturing flexible circuits in high volumes and at low costs.

Unless otherwise indicated herein, the approaches described in this section are not prior art to the claims in this application and are not admitted to be prior art by inclusion in this section.

Radio frequency identification (RFID) device technology is proliferating everywhere and into everything. Right now, a worldwide effort is stepping into high gear to replace the familiar universal product code (UPC) barcodes on products with RFID tags. The ink and labels used to print UPC barcodes is very inexpensive, and the costs of RFID chips and printed circuit antennas are under a lot of pressure to match them. Large, expensive items, of course, are not price sensitive to the cost of a typical RFID tag. But mass produced commodity items need tags that cost only a few cents.

The majority of printed circuit boards (PCBs) are made by depositing a layer of copper cladding over the entire substrate, then subtracting away the unwanted copper by chemical etching, leaving only the desired copper traces. Some PCBs are made by adding traces to a bare substrate by electroplating.

Three common subtractive methods are used to make PCBs. Etch-resistant inks can be screened on the cladding to protect the copper foils that are to remain after etching. Photoengraving uses a photomask to protect the copper foils, and chemical etching removes the unwanted copper from the substrate. Laser-printed transparencies are typically employed for phototools, and direct laser imaging techniques are being used to replace phototools for high-resolution requirements. PCB milling uses a 2-3 axis mechanical milling system to mill away copper foil from the substrate. A PCB milling machine operates like a plotter, receiving commands from files generated in PCB design software and stored in HPGE or Gerber file format.

Additive processes, such as the semi-additive process, starts with an unpatterned board and a thin layer of copper. A reverse mask is then applied. Additional copper is plated onto the board in the unmasked areas. Tin-lead and other surface platings are then applied. The mask is stripped away, and a brief etching step removes the now-exposed thin original copper laminate from the board, isolating the individual traces.

The additive process is commonly used for multi-layer boards because it favors making plating-through holes (vias) in the circuit board.

Circuit etching methods that use chemicals, coatings, and acids are slow, expensive, and not environmentally friendly. Mechanical etching has been growing rapidly in recent years. Mechanical milling involves the use of a precise numerically controlled multi-axis machine tool and a special milling cutter to remove a narrow strip of copper from the boundary of each pad and trace.

Conventional laser etching of circuit traces is from the side with the metal to be etched. The metal, smoke, and debris goes flying directly in the path of the laser beam trying to do its work. The laser and its optics need frequent cleaning in order to maintain etching efficiency. But lasers can be a very fast, environmentally safe way to mass produce printed circuits, e.g., RFIDs on flexible printed circuits (FPC) using DuPont's KAPTON polyimide film.

Thus, there is a need for improved systems and methods for electronic circuit formation. The present invention solves these and other problems by providing systems for reverse side film laser circuit etching.

### SUMMARY

Embodiments of the present invention improve systems and methods related to the formation of electronic circuits and related electronic components.

A direct-write laser lithography embodiment of the present invention comprises a reel-to-reel or sheet feed system that presents the reverse side of a single-sided metal-coated media to a laser for direct patterning of the metal. The laser beam is swept laterally across the media by a moving mirror, and is intense enough to ablate the metal but not so strong as to destroy the media substrate. The ablated metal blows off in a downward direction and is collected for recycling.

According to another embodiment, two or more specialized lasers are used, one tuned to ablate large field areas, and the other tuned to scribe fine features and lines.

According to another embodiment, a laser movement system moves the laser in relation to the metal-coated media in order to direct the laser beam without mirrors.

One feature of certain embodiments of the present invention is a system that can produce RFID circuits on flexible printed circuits at a low cost per unit.

Another feature of certain embodiments of the present invention is a manufacturing method that produces very little waste and that readily recycles the metals ablated from the tapes.

Another feature of certain embodiments of the present invention is a manufacturing method for flexible printed circuits that allows for continuous production.

The following detailed description and accompanying drawings provide a better understanding of the nature and advantages of the present invention.

### BRIEF DESCRIPTION OF THE DRAWINGS

FIG. 1 is a block diagram of a direct-write laser lithography system according to an embodiment of the present invention that uses a single laser to ablate metal from film wound reel-to-reel or sheets fed from a sheet feeding system.

FIG. 2 is a block diagram of a dual direct-write laser lithography system according to an embodiment of the present invention that uses one laser to ablate wide fields of metal, and another laser to ablate narrow fields to form fine lines and features.

FIG. 3 is a plan view diagram of a RFID device constructed with a flex circuit antenna etched by the system of FIG. 1, FIG. 2 or FIG. 4.

FIG. 4 is a cross-sectional view diagram of a reverse-side laser ablation system according to an embodiment of the present invention.

FIGS. 5A-5E are plan views showing thermal isolation ablation performed on a coated film according to certain embodiments of the present invention.

FIG. 6 is a flowchart of a method of laser circuit etching according to an embodiment of the present invention.

FIG. 7 is a block diagram of a control system for controlling laser ablation according to an embodiment of the present invention.

### DETAILED DESCRIPTION

Described herein are techniques for reverse side film laser circuit etching. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

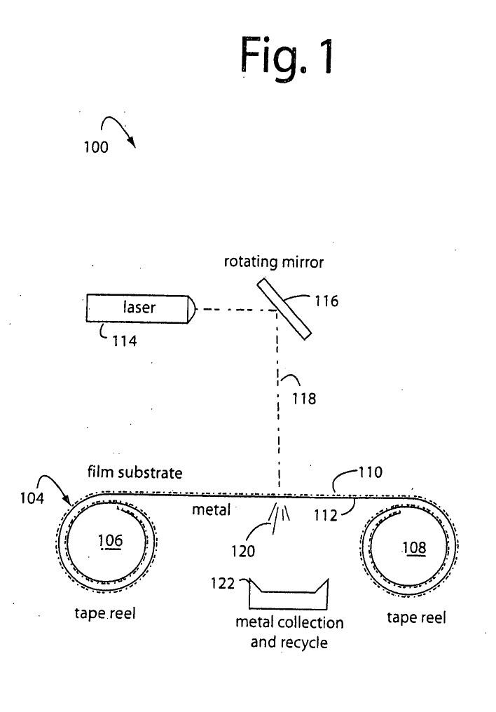

FIG. 1 represents a direct-write laser lithography system embodiment of the present invention, and is referred to herein by the general reference numeral 100. System 100 is used to manufacture flexible printed circuits (FPC), and comprises a metal-on-film substrate tape 104 wound on a supply reel 106 and a take-up reel 108. The tape 104 has a transparent film substrate 110 and a thin-film metal cladding 112. The transparent film substrate 110 may comprise polyimide, PEN, polyester, polycarbonate, etc. The thin-film metal cladding 112 may include copper (Cu), aluminum (Al), platinum (Pt), etc.

A laser 114 is used to ablate off the metal from the backside of tape 104 as it translates from supply reel 106 to take-up reel 108. A mirror 116 moves a laser beam 118 to various lateral points across the tape 104. Once laser beam 118 is positioned properly, a pulse of energy is generated enough to ablate metal 120 away. In such manner, the remaining portions of the metal 112 are patterned to create electrical circuits, e.g., RFID antennas. A metal collection and recycle system 122 captures the ablated metal 120 and recycles it. The metal collection and recycle system 122 may include a vacuum pump.

Observe in the embodiment shown in FIG. 1 that the ablated metal 120 does not fly or plume into the path of laser beam 118 because the ablation is on the opposite side to the laser. The result is less laser energy is needed to get the job done. If the laser energy is too high, the ablated material may convert to plasma and the vapors can coat components of the system 100. One feature of the embodiment shown in FIG. 1 is to carry away pieces for recycling, so it is often desirable that the ablation dislodges or tears away solid chunks of metal. So breaking the adhesive bond between the metal and the substrate of the tape can be desirable feature of the ablation.

Gravity and/or vacuum caused airflow is used to assist the falling away and collection of ablated metal 120.

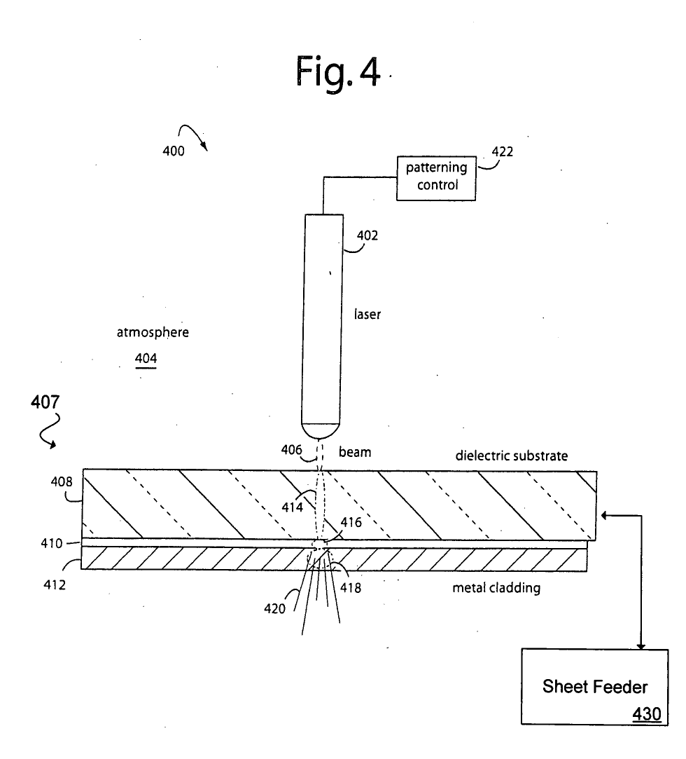

The materials used for the transparent film substrate and the wavelength of laser beam 118 are chosen such that the energy absorbed by the substrate will be minimal and be able to pass the laser energy through to concentrate on ablating the metal 120. This could be assisted by placing an energy absorbing material between the transparent film substrate 110 and a thin-film metal cladding 112. (Further details regarding the energy absorbing material are provided below with reference to FIG. 4.) The choice of type and power level of laser 114 will be empirically derived, but initial indications are that a 15 W diode pumped YAG laser will produce the desired results.

According to other embodiments, the tape 104 is radiused so the substrate 110 is under compression and the metal cladding 112 is under tension where they encounter the laser beam 118. Such mechanical stresses and the force of gravity may assist with ablation and not require all the separation energy come from the laser and its heating effects. According to further embodiments, heating, or pre-heating tape 104 may also be used to assist to get the materials up to the points where the metal will ablate more readily and with less violence. According to other embodiments, the tape 104 may be cooled prior to ablation, for example, using liquid nitrogen. Cooling may make a metal such as copper more brittle so that it ablates more easily. The choice of heating, cooling or neither may depend upon the specific material.

The tape 104 may also be referred to as a coated tape. In general, the term “coated” includes both “laminated”, which refers to an adhesive material between the substrate 110 and the metal cladding 112, as well as “sputtered”, which refers to a chromium material between the substrate 110 and the metal cladding 112. These materials help the substrate 110 and the metal cladding 112 to adhere together.

Although a reel-to-reel tape system is shown in the embodiment of FIG. 1, note that other embodiments may instead use a sheet feeder system, or other structure for presenting the tape 104 for ablation. The choice of reel-to-reel tape system, sheet feeder system, or other structure will depend upon various design factors, including the form factor of the coated tape 104.

The mirror 116 may be implemented in various ways. According to one embodiment, the mirror 116 is a swinging mirror that may be tilted on one or more axes, for example, the x-axis or the y-axis. The mirror 116 may be part of a galvo head device. According to another embodiment, the mirror 116 may be a rotating mirror, for example, a many-sided prism type structure that is rotated to direct the laser beam.

For higher throughput, one laser can have two or more galvo heads for ablating simultaneously.

There is a balance between what kinds of laser beams 118 will be good for wide area ablating of metal, and what kind will provide clean, sharp features. An alternative embodiment of the present invention uses two lasers, one for wide area ablating of metal, and the other set to write clean, sharp features.

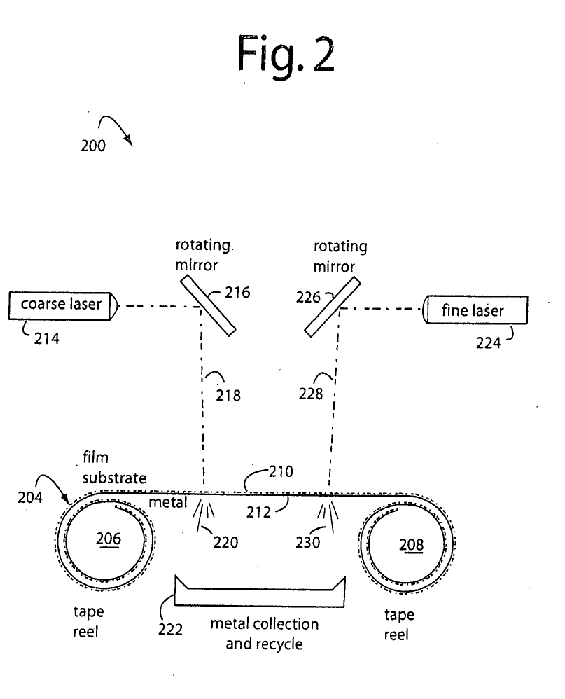

FIG. 2 shows a dual direct-write laser lithography system embodiment of the present invention, and is referred to herein by the general reference numeral 200. System 200 is used to manufacture flexible printed circuits (FPC), and comprises a metal-on-film substrate tape 204 wound on a supply reel 206 and a take-up reel 208. The tape 204 has a transparent film substrate 210 and a thin-film metal cladding 212. The transparent film substrate 210 may comprise polyimide, PEN, polyester, polycarbonate, etc. The thin-film metal cladding 212 may include copper (Cu), aluminum (Al), platinum (Pt), etc.

A fine laser 244 is used to ablate off fine lines of metal from the backside of tape 204 as it translates from supply reel 206 to take-up reel 208. A second mirror 226 moves a fine laser beam 228 to various lateral points across the tape 204. Once fine laser beam 218 is positioned properly, e.g., within 50-micrometers, a pulse of energy is generated to ablate precise lines and spots of metal 230 away.

A coarse laser 214 is used to ablate off wide fields of metal from the backside of tape 204, after the fine laser 244. A first mirror 210 moves a coarse laser beam 218 to various lateral points across the tape 204. Once coarse laser beam 218 is positioned properly, a pulse of energy is generated to ablate field metal 220 away. Such ablated metal takes heat away and is caught and recycled by metal collection and recycle system 222. The metal collection and recycle system 222 may include a vacuum pump.

Gravity and/or vacuum caused airflow is used to assist the falling away and collection of ablated metals 220 and 230.

The mirror 210 or the mirror 226 may be swinging mirrors or rotating mirrors as described above regarding FIG. 1.

According to other embodiments, the tape 204 is radiused so the substrate 210 is under compression and the metal cladding 212 is under tension where they encounter laser beams 218 and/or 228. Such mechanical stresses and the force of gravity can assist with ablation and not require all the separation energy come from the laser and its heating effects. According to further embodiments, heating, or pre-heating tape 204 may also be used to assist to get the materials up to the points where the metal will ablate more readily and with less violence. According to other embodiments, the tape 204 may be cooled prior to ablation, for example, using liquid nitrogen. Cooling may make a metal such as copper more brittle so that it ablates more easily. The choice of heating, cooling or neither may depend upon the specific material.

Having to balance between what kinds of laser beams would be good for wide area ablating of metal, and what kind would provide clean sharp features is avoided in the system 200 of FIG. 2 by using the two different specialized lasers 214 and 224. Otherwise the features and principles of operation are similar between the embodiments of FIG. 1 and FIG. 2. Furthermore, more than two lasers and/or lasers with two or more galvo heads may be used to perform specialized ablations; for example, three lasers may be used to perform course, medium and fine ablations.

Various materials for substrate 110 and 210 can be used, the best depending on several variables. A typical substrate tape is 460 mm wide. Table I summarizes the properties of several popular materials. (As reported by LPKF Laser & Electronics AG.)

TABLE I

| | KAPTON | APICAL | UPILEX | KALADEX | MYLAR | MAKROFOL |
|---|---|---|---|---|---|---|
| Tg (° C.) | 385 | >500 | >500 | 122 | 80 | 153 |
| CTE | 15 | 12 | 8 | 20 | 20 | 70 |
| (ppm/° C.) | | | | | | |
| tensile | 24 | 15-24 | 35 | 32 | 28-32 | 20-25 |
| strength | | | | | | |
| Kpsi | | | | | | |
| Water | 2.9 | 2.2 | 1.2 | <1 | <1 | 0.35 |
| absorp. | | | | | | |
| (%/wt.) | | | | | | |
| dielectric | ? | 9.4 | 6.8 | 3.4 | 3.5 | 2.8 |
| strength | | | | | | |

KAPTON, APICAL, and UPILEX are brand names of various forms of polyimide, KALADEX is a polyethylene naphthalate (PEN), MYLAR is a polyester, and MAKROFOL and LEXAN are polycarbonates.

The choice of metal for cladding 112 and 212 depends on several tradeoffs. In general, the thinner the metal, the easier is the laser ablation. Thinner materials will have higher sheet resistances, as measured in Ohms per square. A balance between these is to be made in each embodiment. Copper is a good choice for circuit wiring, but the copper material absorbs and dissipates heat very efficiently, and that counters the spot heating effects the laser is trying to obtain for ablation. Aluminum is better in this regard, but gold and platinum may have to be used if the application is in a corrosive environment. The metals' reflectivity, absorptivity, and thermal conductivity are key parameters in the choice of metal to use. LPKF Laser & Electronics AG reported on three of these metals, as in Table II.

TABLE II

| | reflectivity | thermal conductivity | |
|---|---|---|---|
| metal | 248 nm | (W/(cm² ° K) | absorptivity 248 nm |
| copper | 0.366 | 3.98 | 0.62 |
| gold | 0.319 | 3.15 | 0.66 |
| aluminum | 0.924 | 2.37 | |

Early proof-of-concept tests were made with different thicknesses of metal on a polyethylene terephthalate (PET) substrate, and at different reel-to-reel tape speeds, e.g., 0.2 μm Cu at 2.5 m/s, 0.5 μm Cu at 2.5 m/s, 0.2 μm Al at 3.0 m/s, and 0.5 μm Al at 3.0 m/s. The laser was a 15 W diode pumped YAG laser.

Many kinds of lasing mediums are used for lasers, and the mediums determine the wavelength of the coherent light produced. The right one to use here depends on the films, metals, and processing speeds decided. Excimer lasers operate in the ultraviolet (UV), below 425 nm. The Argon:Fluorine (Ar:F) laser operates at 193 nm, and Krypton:Fluoride (Kr:F) at 248 nm. The nitrogen UV laser emits light at 337 nm. The Argon laser is a continuous wave (CW) gas laser that emits a blue-green light at 488 and 514 nm. The potassium-titanyl-phosphate (KTP) crystal laser operates in green, around 520 nm. Pulsed dye lasers are yellow and about 577-585 nm. The ruby laser is red and about 694 nm. The synthetic chrysoberyl “alexandrite” laser operates in the deep red at about 755 nm. The diode laser operates in the near infrared at about 800-900 nm. The right laser to use in embodiments of the present invention will probably be the hazardous Class-IV types, e.g., greater than 500 mW continuous, or 10 J/cm² pulsed.

YAG lasers are infrared types that use yttrium-aluniinum-garnet crystal rods as the lasing medium. Rare earth dopings, such as neodymium (Nd), erbium (Er) or holmium (Ho), are responsible for the different properties of each laser. The Nd:YAG laser operates at about 1064 nm, the Ho:YAG laser operates at about 2070 nm, and the “erbium” Er:YAG laser operates at just about 2940 nm. YAG lasers may be operated in continuous, pulsed, or Q-Switched modes. The carbon-dioxide (CO₂) laser has the longest wavelength at 10600 mm.

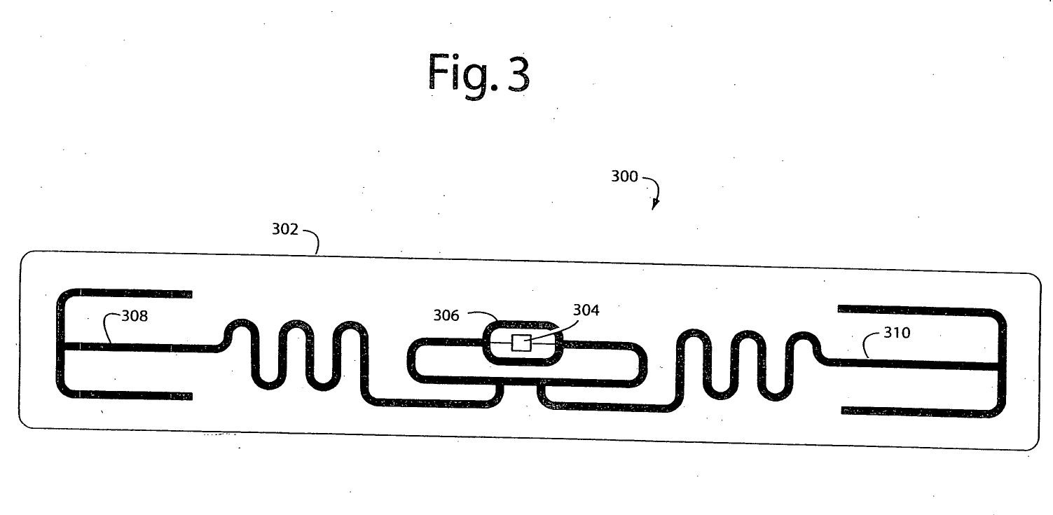

FIG. 3 represents an RFID device 300 with an antenna on a substrate manufactured with system 100 or system 200 (or system 400 described below with reference to FIG. 4). The RFID device 300 comprises a film substrate 302 on which has been laser-patterned a folded dipole antenna. A RFID chip 304 is attached to a bond area 306, and these are connected to left and right antenna elements 308 and 310. The dimensions of the RFID device 300 may vary as desired, for example, between 1 and 4 inches in length.

The RFID device 300 is one example of an electrical circuit that may be formed according to embodiments of the present invention. Embodiments of the present invention may also be used to form other electrical circuits and electronic devices. As another example, embodiments of the present invention may be used to form thermal circuits such as flexible heaters.

FIG. 4 represents a reverse-side laser ablatement system embodiment of the present invention, which is referred to herein by the general reference numeral 400. System 400 comprises a laser 402, such as a YAG laser that can operate a relatively high power levels, for example, 15 W. It operates in an atmosphere 404 selected with a view toward improving laser operation and reducing the cost of operating the whole of system 404. For example, some applications will be able to do best with an atmosphere 404 of either normal air, reduced pressure, vacuum, or dry, or inert atmospheres like nitrogen or argon. A beam 406 of laser light travels through atmosphere 404 and enters the “back side” of a coated material 407 comprising a dielectric substrate 408, an optional intermediate layer 410, and a metal cladding 412. If used, the intermediate layer 410 may comprise UV absorption materials, in the case of a UV laser 402, or other wavelength selective energy absorbing materials coordinated with the selection of laser 402. A sheet feeder system 430 moves the coated material 407.

It is a feature of the embodiment shown in FIG. 4 that the material that comprises dielectric substrate 408 be substantially transparent to the laser light beam 406 so that a transitioning beam 414 will be able to deposit a maximum of energy in an intermediate heating area 416 (if present) and metal ablatement area 418. It is desirable that the material of dielectric substrate 408 survive the exposure to laser beam 406 with substantially no damage or heating. It can do that if such material is effective at transmitting the light wavelengths used by laser 402. So the choice of laser can affect the choice of materials for dielectric substrate 408, and vice versa.

Such heating area 416 is used to overpressure ablatement area 418 and stress it to assist in ablating metal 420. If intermediate layer 410 is not used, then transitioning beam 414 reaches metal ablatement area 418 directly and melts and vaporizes metal to produce ablating metal 420 according to patterns written by a patterning control 422. The metal cladding 412 may be pre-patterned to reduce the amount of metal that must be ablated on-line in final patterning, e.g., into RFID antenna circuits and other electronics boards.

In general, metal cladding 412 will comprise material conductive to electricity, and dielectric substrate 408 will comprise electrically insulative materials so that patterning control 422 can produce rigid or flexible printed circuits. Typical metals are copper, aluminum, gold, silver, platinum, etc. Typical insulators are polyimide, polycarbonate, silicon dioxide, alumina, glass, diamond, etc., in tapes, boards, films, and dice.

Laser 402, and in particular beam 406, is positioned in coordination with patterning control 422 by means such as pen-plotter mechanisms, x-y stages, micro-mirrors, a galvo head device, etc. according to design tradeoffs in various embodiments. The patterning control 422 in combination with the sheet feeder system 430 work together so that the laser beam 406 ablates the metal from the coated material 407 at the desired location. Additional lasers can be included to improve job throughput, or they can be specialized to do wide area or fine feature ablations. Such lasers can use different wavelengths and laser types to assist in such specialization and job sharing. According to another embodiment, to improve throughput, a beam splitter may split a beam from a single laser into multiple beams that are directed by multiple galvo head devices.

The use of a pen-plotter type positioning mechanism for laser 402 permits the propagation distance that beam 406 has to travel through atmosphere 404 to be reduced as compared to certain embodiments that interpose a mirror between the laser and the substrate 408. Such then would permit atmosphere 404 to be ordinary air, whereas a longer travel distance could necessitate the use of vacuum in certain embodiments.

The coated material 407 may be implemented in various form factors, and the components of the system 400 may be varied in accordance with the form factor of the coated material 407. Conversely, the form factor of the coated material 407 may be varied in accordance with the components of the system 400. For example, a reel-to-reel tape system (similar to that shown in FIG. 1) may be implemented in the system 400, in which case the coated material 407 may be a coated tape. As another example, the metal layer 412 may have a thickness such that coated material 407 may be in sheet form, in which case a sheet feeder may be implemented in the system 400.

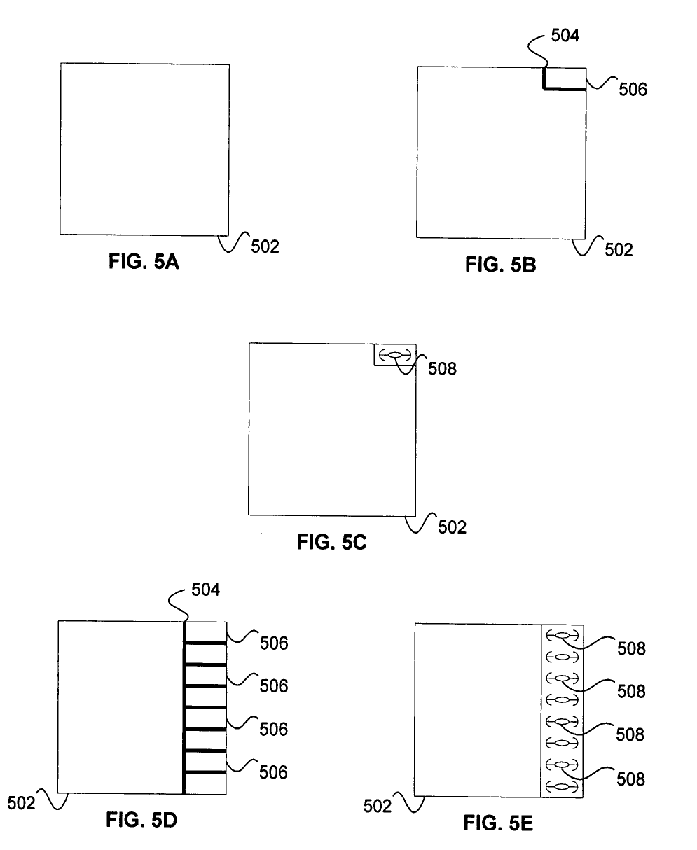

FIGS. 5A-5E are plan views showing thermal isolation ablation performed on a coated film according to certain embodiments of the present invention. In certain embodiments, it is desirable to perform thermal isolation ablation prior to performing structural ablation. The determination of when to perform thermal isolation ablation will depend upon various factors, such as the power of the laser, the type of metal, the thickness of the metal, etc. For example, if the metal being ablated is such that the energy of the laser becomes undesirably dissipated by thermal conduction of the laser energy by other portions of the coated sheet, then thermal isolation ablation may be performed to mitigate this issue. Thermal isolation ablation may be performed by the embodiment shown in FIG. 1, the embodiment shown in FIG. 2, or the embodiment shown in FIG. 4.

FIG. 5A shows a portion of a coated sheet 502 prior to laser ablation. The coated sheet may be in the form of a tape or sheet and includes a dielectric layer and a metal layer as described above.

FIG. 5B shows the coated sheet 502 after thermal isolation ablation has been performed. The metal has been ablated (for example, by the laser 114) from an area 504 in order to thermally isolate a portion 506 from the remaining metal portions of the coated sheet 502. Note that the metal is ablated and the dielectric substrate remains intact, as discussed above with reference to other embodiments of the present invention.

FIG. 5C shows that structural ablation has been performed on the isolated portion 506 (see FIG. 5B) to form circuit structures on the coated sheet 502, such as an RFID antenna 508. Since the portion 506 has been thermally isolated from the other metal portions of the coated sheet 502 (see FIG. 5B), the energy of the laser does not dissipate over the entirety of the coated sheet 502 when structural ablation is being performed. Thus, more of the laser energy remains localized in the ablation area, and can improve the performance and efficiency of the structural ablation as compared to embodiments that do not involve thermal isolation ablation.

FIG. 5D shows the coated sheet 502 after a series of thermal isolation ablations have been performed. In certain embodiments, it is desirable to perform a series of thermal isolation ablations prior to performing structural ablation in the thermally isolated portions 506 of the coated sheet 502. Otherwise the thermal isolation ablation is similar to that discussed above with reference to FIG. 5B.

FIG. 5E shows that structural ablation has been performed on the isolated portions 506 (see FIG. 5D) to form circuit structures on the coated sheet 502, such as the RFID antennas 508. Otherwise the structural ablation is similar to that discussed above with reference to FIG. 5C.

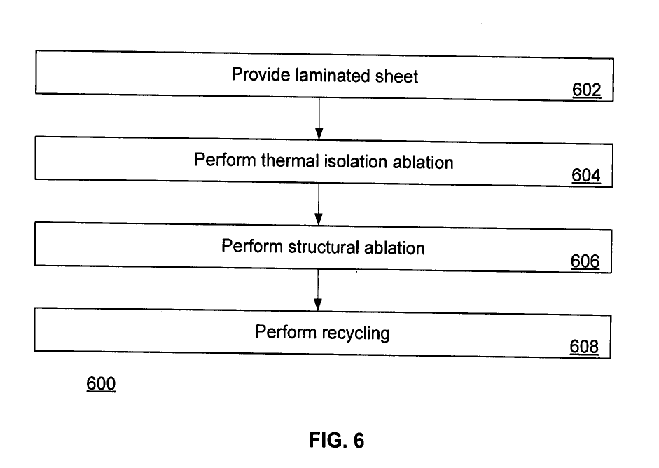

FIG. 6 is a flowchart of a method 600 of laser circuit etching according to an embodiment of the present invention. The method 600 may be implemented by various embodiments of the present invention, such as the embodiment shown in FIG. 1, the embodiment shown in FIG. 2, the embodiment shown in FIG. 4, etc., and variations thereof.

In step 602, a coated sheet is provided. As discussed above, the coated sheet comprises a dielectric substrate layer and a metal foil layer. The coated sheet may be in various form factors, such as in tape form or in sheet form. The specific form factor of the coated sheet may depend upon the specific embodiment of the laser etching device. The form factor of the coated sheet may also depend upon the properties of the metal layer. For example, a tape form factor may be suitable for a thinner metal layer, and a sheet form factor may be suitable for a thicker metal layer.

In step 604, thermal isolation ablation is performed. Which laser performs the thermal isolation ablation will depend upon the specific embodiment of the invention. For example, for the embodiment shown in FIG. 1, the laser 114 may perform the thermal isolation ablation. For the embodiment shown in FIG. 2, the course laser 214 may perform the thermal isolation ablation. Alternatively, the fine laser 224 may perform the thermal isolation ablation in other embodiments of the present invention.

In step 606, structural ablation is performed. Which laser performs the structural ablation, and in what sequence, will depend upon the specific embodiment of the invention. For example, for the embodiment shown in FIG. 2, the course laser 214 may perform wide area ablation, then the fine laser 224 may perform narrow area ablation. Alternatively, the fine laser 224 may perform narrow area ablation, then the course laser 214 may perform wide area ablation. Or alternatively, the course laser 214 may perform a portion of the wide area ablation, the fine laser 224 may perform narrow area ablation, then the course laser 214 may perform another portion of the wide area ablation. Or alternatively, the fine laser 224 may perform a portion of the narrow area ablation, the course laser 224 may perform wide area ablation, then the fine laser 224 may perform another portion of the narrow area ablation.

As discussed above with reference to FIGS. 5A-5E, the thermal isolation ablation and the structural ablation may be performed sequentially or in alternation. According to one embodiment of the present invention, structural ablation is performed on a segment after the segment has been thermally isolated. (See FIGS. 5B-5C and related discussion.) According to another embodiment of the present invention, a sequence of thermal isolation ablations are performed (see FIG. 5D and related discussion), then a sequence of structural ablations are performed (see FIG. 5E and related discussion). The exact sequence of thermal isolation ablations and structural ablations may vary according to various factors, such as the desired use of the laser(s), the structures that controls the movement of the laser or the laser beam, the specifics of the circuits to be etched, etc.

In step 608, recycling of the ablated metal is performed. The recycling process is as described above.

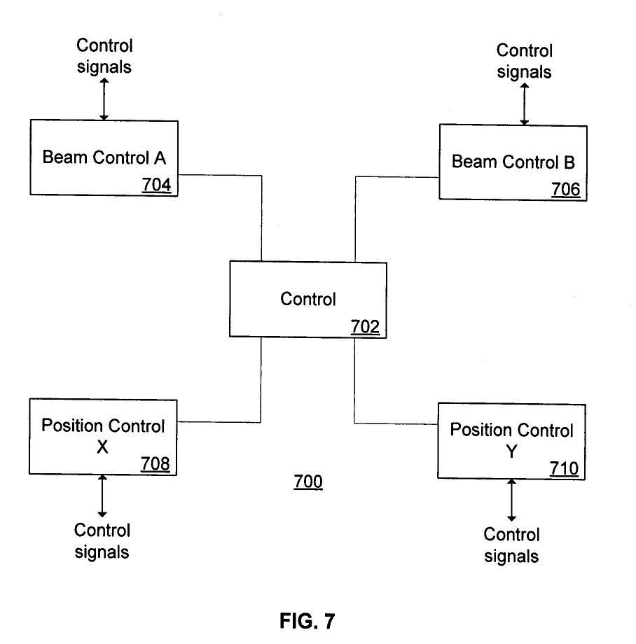

FIG. 7 is a block diagram of a control system 700 for controlling laser ablation according to an embodiment of the present invention. The control system 700 includes a master control block 702, beam control A block 704, optional beam control B block 706, position control X block 708, and position control Y block 710. The control system 700 generally controls the operation of the laser etching system according to the various embodiments of the present invention. The control system 700 may be implemented in hardware, software, or a combination of hardware and software.

The master control block 702 generally coordinates the other components of the control system 700. The master control block may store a program or other set of instructions for performing a specific set of ablations, and may then instruct the other components of the control system to in accordance with the program or other instructions.

The beam control A block 704 controls the operation of a laser in an embodiment of the present invention (for example, laser 114 in FIG. 1) via control signals. The control signals may indicate the activation of the laser, the power of the laser, or other controllable attributes of the laser in accordance with the specifics of the ablation desired.

The beam control B block 706 is optional in that it controls the operation of a second laser, when present, in an embodiment of the present invention (for example, fine laser 224 in FIG. 2) via control signals. The control signals may indicate the activation of the laser, the power of the laser, or other controllable attributes of the laser in accordance with the specifics of the ablation desired. In systems having only a single laser, the beam control B block 706 is not required.

The position control X block 708 controls, via control signals, the relative position between the laser and the coated sheet in an embodiment of the present invention. For example, in the laser etching system 100 of FIG. 1, the position control X block 708 controls the movement of the coated film 104 from one reel to another. The movement may be from the reel 108 to the reel 106, or vice versa. As another example, in the laser etching system 400 of FIG. 4, the position control X block instructs the patterning control 422, for example, to move the laser 402 along an x-axis, along a y-axis, or in a combination of x-axis and y-axis movement.

The position control Y block 710 controls, via control signals, other aspects of the relative position between the laser and the coated sheet not otherwise controlled by the position control X block 708 in an embodiment of the present invention. For example, in the laser etching system 100 of FIG. 1, the position control Y block 710 controls the mirror 116. In such manner, the movement of the coated film 104 and the mirror 116 can be coordinated so that the laser beam 118 ablates at the desired location on the coated film 104.

As discussed above, the systems and methods according to various embodiments of the present invention are suitable for flexible circuit manufacturing techniques. Flexible circuits may be used in many different applications, including RFID antennas, RFID tag circuitry, membrane switches, flexible heaters and printed circuits, data compact disks, and data video disks.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A method of etching metal structures on a substrate, said method comprising the steps of:
providing a coated sheet, said coated sheet having a first side that comprises a dielectric substrate and a second side that comprises a metal; and
controlling a laser to generate a laser beam toward said first side of said coated sheet such that said laser beam passes through said first side and ablates portions of said second side.

2. The method of claim 1, further comprising:
configuring said coated sheet into a tape;
mounting said tape into a reel-to-reel transport system; and
controlling said reel-to-reel transport system to move said tape relative to said laser.

3. The method of claim 1, further comprising:
orienting said coated sheet such that said second side faces downward and gravity helps to move ablated material away from said coated sheet for recycling.

4. The method of claim 1, wherein said laser comprises a first laser, further comprising:
controlling a second laser to generate a second laser beam toward said first side of said coated sheet such that said second laser beam passes through said first side and ablates additional portions of said second side, wherein one of said first laser and said second laser is tuned to ablate a large area, wherein another of said first laser and said second laser is tuned to ablate a small area, and wherein operation of said first laser and said second laser is coordinated to provide a single result.

5. The method of claim 1, further comprising:
moving a mirror in a path of said laser beam to provide for transverse movement of said laser beam across said coated sheet.

6. The method of claim 1, further comprising:
heating said coated sheet, in order to reduce an amount of laser power needed to ablate said metal.

7. The method of claim 1, further comprising:
mechanically stressing said coated sheet, in order to reduce an amount of laser power needed to ablate said metal.

8. The method of claim 1, further comprising:
cooling said coated sheet, in order to reduce an amount of laser power needed to ablate said metal.

9. The method of claim 1, wherein said step of controlling said laser further comprises:
controlling said laser to generate said laser beam selectively in a thermal isolation mode and in a structural mode, wherein said thermal isolation mode operates to perform ablation to thermally isolate a portion of said second side, and wherein said structural mode operates to perform ablation to form structures on said portion having been thermally isolated.

10. The method of claim 1, further comprising:
orienting said coated sheet such that said second side faces downward, and vacuum directed airflow helps to move said portions of said second side away from said coated sheet for recycling after having been ablated.

11. An apparatus including a flexible circuit etching system, said flexible circuit etching system comprising:
a reel-to-reel tape system that linearly presents a coated tape, wherein said coated tape has a first side that comprises a dielectric substrate and a second side that comprises a metal;
a laser that generates a laser beam having a power sufficient to ablate said metal from said second side of said coated tape; and
a mirror that controllably moves to direct said laser beam toward said first side of said coated tape such that said laser beam passes through said first side and ablates portions of said second side.

12. The apparatus of claim 11, further comprising:
a collection and recycling system positioned to collect ablated portions of said metal having been ablated by said laser beam.

13. The apparatus of claim 11, further comprising:
a control system, coupled to said reel-to-reel tape system, to said laser, and to said mirror, that controls said reel-to-reel tape system, said laser, and said mirror,
wherein said control system controls said laser to generate said laser beam selectively in a thermal isolation mode and in a structural mode, wherein said thermal isolation mode operates to perform ablation to thermally isolate a portion of said second side, and wherein said structural mode operates to perform ablation to form structures on said portion having been thermally isolated, and
wherein said control system controls said reel-to-reel tape system and said mirror to coordinate appropriate placement of said coated tape in accordance with control of said laser.

14. The apparatus of claim 11, further comprising:
a plurality of galvo head devices that include a plurality of mirrors that controllably each move to direct a plurality of laser beams toward said first side of said coated tape such that said plurality of laser beams each pass through said first side and ablate portions of said second side.

15. An apparatus including a dual laser flexible circuit etching system, said dual laser flexible circuit etching system comprising:
a reel-to-reel tape system that linearly presents a coated tape, wherein said coated tape has a first side that comprises a dielectric substrate and a second side that comprises a metal;
a first laser that generates a first laser beam having a power sufficient to ablate a large area of said metal from said second side of said coated tape;
a first mirror that controllably moves to direct said first laser beam toward said first side of said coated tape such that said first laser beam passes through said first side and ablates large portions of said second side;
a second laser that generates a second laser beam having a power sufficient to ablate a small area of said metal from said second side of said coated tape; and
a second mirror that controllably moves to direct said second laser beam toward said first side of said coated tape such that said second laser beam passes through said first side and ablates small portions of said second side.

16. The apparatus of claim 15, further comprising:
a control system, coupled to said reel-to-reel tape system, to said first laser, to said first mirror, to said second laser, and to said second mirror, that controls said reel-to-reel tape system, said first laser, said first mirror, said second laser, and said second mirror,
wherein said control system controls said first laser and said second laser to generate said first laser beam and said second laser beam selectively in a thermal isolation mode and in a structural mode, wherein said thermal isolation mode operates to perform ablation to thermally isolate a portion of said second side, and wherein said structural mode operates to perform ablation to form structures on said portion having been thermally isolated, and
wherein said control system controls said reel-to-reel tape system, said first mirror and said second mirror to coordinate appropriate placement of said coated tape in accordance with control of said first laser and said second laser.

17. An apparatus including a laser ablation machine for patterning metal cladding on a dielectric substrate, said laser ablation machine comprising:
a laser; and
a patterning control system that positions said laser in relation to a coated sheet, wherein said coated sheet has a first side that comprises a dielectric substrate and a second side that comprises a metal,
wherein said laser generates a laser beam having a power sufficient to ablate said metal from said second side of said coated tape, and wherein said laser beam passes through said first side and ablates portions of said second side.

18. The apparatus of claim 17, further comprising:
a control system, coupled to said laser and to said patterning control system, that controls said laser and said patterning control system,
wherein said control system controls said laser to generate said laser beam selectively in a thermal isolation mode and in a structural mode, wherein said thermal isolation mode operates to perform ablation to thermally isolate a portion of said second side, and wherein said structural mode operates to perform ablation to form structures on said portion having been thermally isolated, and
wherein said control system controls said patterning control system to coordinate appropriate placement of said laser in relation to said coated sheet in accordance with control of said laser.

19. An apparatus including an electrical circuit, said electrical circuit produced by a method comprising the steps of:
providing a coated sheet, said coated sheet having a first side that comprises a dielectric substrate and a second side that comprises a metal; and
controlling a laser to generate a laser beam toward said first side of said coated sheet such that said laser beam passes through said first side and ablates portions of said second side to form said electrical circuit on said coated sheet.

20. The apparatus of claim 19, wherein said electrical circuit comprises an antenna for a radio frequency identification (RFID) tag.

21. The apparatus of claim 19, wherein said electrical circuit comprises a thermal circuit.
